(19) United States
(12) Patent Application Publication
(10) Pub. No.: US 2023/0385236 A1
(43) Pub. Date: Nov. 30, 2023

(54) Maintaining Stale Files to Minimize Computing Costs

(71) Applicant: Microsoft Technology Licensing, LLC, Redmond, WA (US)

(72) Inventors: Brian D. Jones, Woodinville, WA (US); Daron Spektor, Seattle, WA (US)

(73) Assignee: Microsoft Technology Licensing, LLC, Redmond, WA (US)

(21) Appl. No.: 17/804,609

(22) Filed: May 31, 2022

(51) Int. Cl. G06F 16/11; G06F 16/14

(52) U.S. Cl. CPC G06F 16/125; G06F 16/14

(57) ABSTRACT

Examples of the present disclosure describe systems and methods for maintaining stale files to minimize computing costs. In examples, a determination is made regarding whether a hydrated file is eligible to remain temporarily stale. If the hydrated file is determined to be eligible to remain temporarily stale, the hydrated file is caused to remain stale at a time when a content refresh for the hydrated file is pending. While the hydrated file remains stale, a set of rules for determining whether the hydrated file should be refreshed is evaluated. If, based on the set of rules, it is determined that the hydrated file should be refreshed, the hydrated file is refreshed.

### BACKGROUND

Files in a synchronized computing environment are either in a hydrated state or a dehydrated state. As only these two states of file hydration exist, devices in the synchronized computing environment must attempt to synchronize a file that has been modified upon detecting the modification. For hydrated files, this method of synchronization means that a client device must always download a modified file as soon as possible to keep the file up-to-date. However, this method of synchronization does not consider that a user may not immediately need or care about the modified file.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for maintaining stale files to minimize computing costs. In examples, a determination is made regarding whether a hydrated file is eligible to remain temporarily stale. If the hydrated file is determined to be eligible to remain temporarily stale, the hydrated file is caused to remain stale at a time when a content refresh for the hydrated file is pending. While the hydrated file remains stale, a set of rules for determining whether the hydrated file should be refreshed is evaluated. If, based on the set of rules, it is determined that the hydrated file should be refreshed, the hydrated file is refreshed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an overview of an example system for maintaining stale files to minimize computing costs.

FIG. 2 illustrates an example process flow for maintaining stale files to minimize computing costs.

FIG. 3 illustrates an example method for maintaining stale files to minimize computing costs.

FIG. 4 is a block diagram illustrating example physical components of a computing device for practicing aspects of the disclosure.

FIGS. 5A and 5B are simplified block diagrams of an example mobile computing device for practicing aspects of the present disclosure.

FIG. 6 is a simplified block diagram of an example distributed computing system for practicing aspects of the present disclosure.

FIG. 7 illustrates an example tablet computing device for executing one or more aspects of the present disclosure.

### DETAILED DESCRIPTION

In a synchronized computing environment, files are synchronized between two or more computing devices, such as a client device and a server device. The files in a synchronized computing environment exist in either a hydrated state or a dehydrated state. In a hydrated state, the entirety of a file is stored on disk by a first device (e.g., a server device) and a second device (e.g., a client device). In a dehydrated state, the entirety of a file is stored on disk by the first device and a placeholder file of the file is stored on disk by the second device. In examples, the placeholder file comprises a subset of the content of the hydrated file, which can range from almost no content (e.g., a zero byte or small-sized file) to almost all of the content of the hydrated file. For instance, the placeholder file may comprise metadata properties of the file and/or portions of content of the file, such as a thumbnail of the file, a size of the dehydrated file, a size of the file when hydrated (e.g., the size of the file stored by the first device), the last modification time/date of the file stored by the first device, a duration of a video or audio content, dimensions of an image, a name of the file, a pointer to the file stored by the first device, etc.

Each file stored by the second device may be associated with a hydration state that dictates whether a file should be hydrated or dehydrated. As one example, a “Pinned” state indicates that a file is to be kept in a hydrated state, whereas an “Unpinned” state indicates that a file is to be kept in a dehydrated state. The hydration state of a file may be assigned directly to a file, inherited from a file folder or file system, or otherwise assigned to a file. For instance, a file stored in a file folder marked with a Pinned state will inherit (e.g., be assigned) the Pinned state from the file folder; thus, the file will be kept in a hydrated state.

Historically, when a file stored by the first device is modified, a corresponding hydrated file stored by the second device is immediately refreshed (e.g., synchronized with the file stored by the first device). The immediate refreshing of the hydrated file stored by the second device ensures that Pinned and otherwise hydrated files stored by the second device are kept up-to-date. However, this refreshing method does not consider that a user may not immediately need or care about the modification made to a file stored by the first device. For example, the user may access the file rarely or may no longer need the file at all. In such an example, immediately refreshing the file causes computing costs (e.g., costs associated with bandwidth, CPU usage, storage) to be immediately, and needlessly, incurred. As such, a new hydration state is needed to allow hydrated files to remain stale (e.g., unsynchronized with the file stored by the first device) until an event occurs or a decision is made to refresh the file.

Accordingly, the present disclosure describes systems and methods for maintaining stale files to minimize computing costs. In examples, a determination is made regarding whether a hydrated file is eligible to remain temporarily stale. The determination may include an analysis of whether the hydrated file has been assigned a Pinned state. If the hydrated file is determined to be eligible to remain temporarily stale (e.g., the file has not been assigned a Pinned state), the hydrated file is caused to remain stale at a time when a content refresh for the hydrated file is pending. In examples, a pending content refresh may indicate that a file stored by the first device has been modified. Alternatively, a pending content refresh may occur in accordance with a predefined time interval (e.g., a one month file refresh cycle or a nightly backup procedure), upon user request, or in response to an event (e.g., the expiration of the file, a modification in file privileges, a modification of a service level agreement (SLA)). Causing the hydrated file to remain stale may comprise actively ignoring a refresh notification (e.g., a notification indicating the pending content fresh) from the first device or preventing the second device from acting on the refresh notification.

During the time period in which the hydrated file is caused to remain stale, the second device (or the first device) evaluates a set of rules to determine whether the hydrated file should be refreshed. The set of rules may provide an analysis of metadata properties of the hydrated file, service load characteristics, throttling conditions, conditions during peak and off-peak times, file type classifications for the hydrated file. In at least one example, the set of rules is a predictive algorithm that is used to predict whether and/or when a user is likely to view or edit a file (e.g., a hydrated file or a dehydrated file). The prediction may be based on user usage information (e.g., an open event, a browse event, an @ mention, historical access times). If, based on the set of rules, it is determined that the hydrated file should be refreshed, the second device refreshes the hydrated file.

Thus, the present disclosure provides a plurality of technical benefits and improvements over previous file synchronization solutions. These technical benefits and improvements include: creating a new hydration state for files in synchronized computing environments; delaying the computing costs associated with a file refresh, thereby enabling the computing costs to allocated over time, safely throttled without (or with minimal) user impact, or neglected until a user elects to open a file; and generating and/or using predictive algorithms to predict when a user is likely to view or edit a file, among other examples.

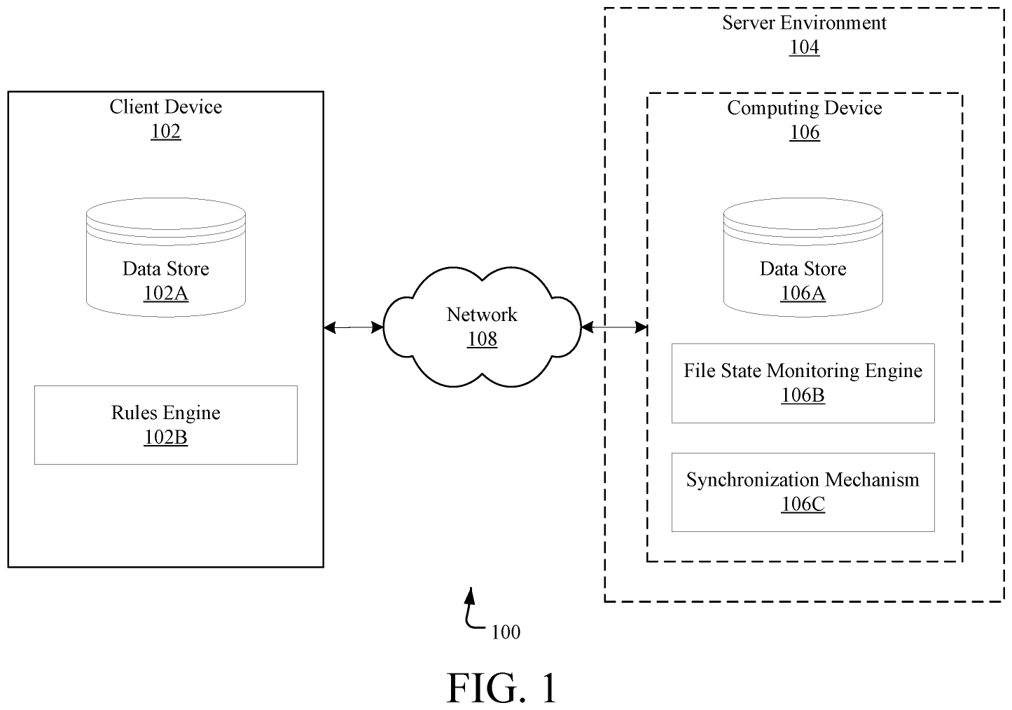

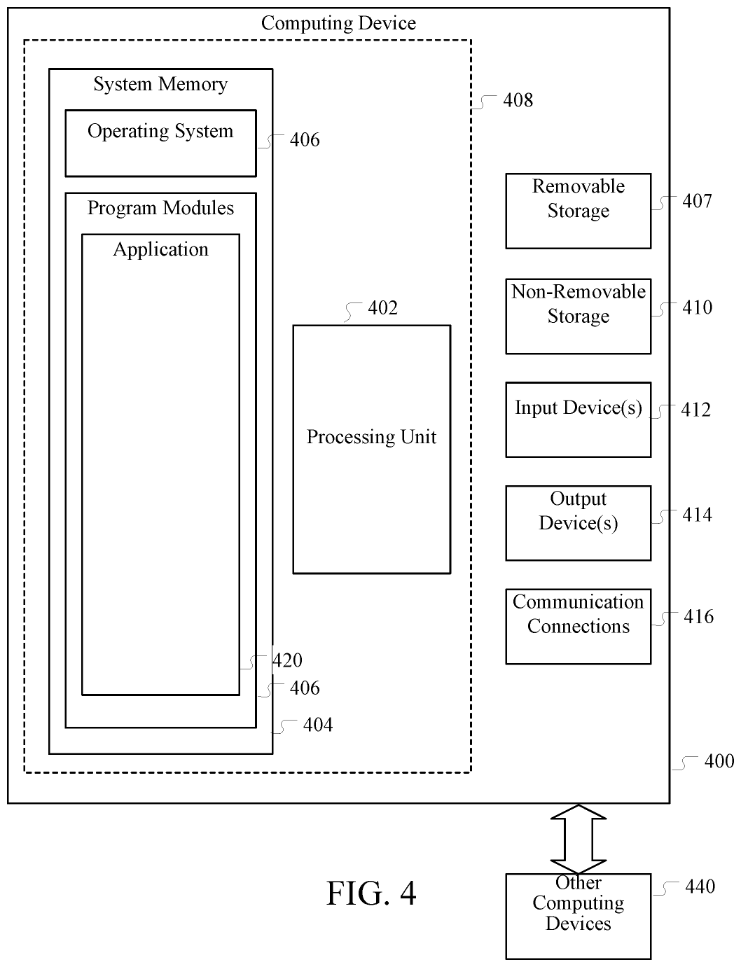

FIG. 1 illustrates an overview of an example system for maintaining stale files to minimize computing costs. Example system 100 as presented is a combination of interdependent components that interact to form an integrated whole. Components of system 100 may be hardware components or software components (e.g., applications, application programming interfaces (APIs), modules, virtual machines, or runtime libraries) implemented on and/or executed by hardware components of system 100. In one example, components of systems disclosed herein are implemented on a single processing device. The processing device may provide an operating environment for software components to execute and utilize resources or facilities of such a system. An example of processing device(s) comprising such an operating environment is depicted in FIGS. 4-7. In another example, the components of systems disclosed herein are distributed across multiple processing devices. For instance, input may be entered on a user device or client device and information may be processed on or accessed from other devices in a network, such as one or more cloud devices or web server devices.

In FIG. 1, system 100 comprises client device 102, data store 102A, rules engine 102B, service environment 104, computing device 106, data store 106A, file state monitoring engine 106B, synchronization mechanism 106C, and network 108. The scale and structure of systems such as system 100 may vary and may include additional or fewer components than those described in FIG. 1. As one example, computing device 106 may be located outside of service environment 104, such as within a computing environment of client device 102. As another example, rules engine 102B may be located in service environment 104 and/or synchronization mechanism 106C may be located in client device 102.

Client device 102 is configured to detect and/or collect input data from one or more users or user devices. In some examples, the input data corresponds to user interaction with one or more software applications or services implemented by, or accessible to, client device 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of an activity, such as a task, a project, or a data request. The input data may include, for example, voice input, touch input, text-based input, gesture input, video input, and/or image input. The input data may be detected/collected using one or more sensor components of client device 102. Examples of sensors include microphones, touch-based sensors, geolocation sensors, accelerometers, optical/magnetic sensors, gyroscopes, keyboards, and pointing/selection tools. Examples of client device 102 include personal computers (PCs), mobile devices (e.g., smartphones, tablets, laptops, personal digital assistants (PDAs)), server devices, wearable devices (e.g., smart watches, smart eyewear, fitness trackers, smart clothing, body-mounted devices, head-mounted displays), gaming consoles or devices, and Internet of Things (IoT) devices.

Client device 102 comprises data store 102A and rules engine 102B. Data store 102A is configured to store files and content associated with the files. The files may comprise the input data collected by client device 102 or input data collected by any other device. In examples, data store 102A comprises hydrated and/or dehydrated files. The hydrated and/or dehydrated files may be manually or automatically assigned a hydration state (e.g., Pinned or Unpinned) that dictates whether a file should be hydrated or dehydrated. As one example, files that are stored in a file folder having a Pinned state parameter set for the file folder are automatically assigned a Pinned state (e.g., the files inherit the Pinned state from the file folder). The hydration state may be stored as a metadata property of the file, such as a metadata tag, a flag, or other descriptor.

Rules engine 102B is configured to evaluate a set of rules for refreshing hydrated files. In examples, evaluating the rules comprises applying a predictive model (e.g., a linear regression model, a time series model, a decision tree, a neural network) or other decision-making logic mechanisms to a set of rules. The set of rules may provide an analysis of metadata properties of the hydrated file (e.g., creation data/time, last access or modification date/time, refresh priority), current service load characteristics of client device 102 or computing device 106 (e.g., bandwidth throttling conditions, conditions during peak and off-peak, CPU usage, memory usage, storage usage), file type classifications for the hydrated file, user usage information (e.g., an open event, a browse event, an @ mention, historical access times, user activity of a user's social circle), user-specified rules or policies (e.g., user or tenant policies regarding hydrated or dehydrated file refreshing), event information (e.g., known or upcoming events relating to a specific topic or involving one or more files), or the like.

In examples, based on evaluating the set of rules, rules engine 102B provides an instruction or notification indicating whether the hydrated file should be refreshed. For instance, in response to determining that a hydrated file should be refreshed, rules engine 102B may send a refresh request to computing device 106 via network 108. Examples of network 108 include a private area network (PAN), a local area network (LAN), a wide area network (WAN), and the like. Although network 108 is depicted as a single network, network 108 may represent several networks of similar or varying types. In response to determining that a hydrated file should remain stale (e.g., should not be refreshed), rules engine 102B may prevent a hydrated file from being refreshed. For instance, rules engine 102B may cause client device 102 to ignore a refresh notification or prevent the execution of a refresh operation.

Service environment 104 is configured to provide client device 102 access to various computing services and resources (e.g., applications, devices, storage, processing power, networking, analytics, intelligence). Service environment 104 may be implemented in a cloud-based or server-based environment. Alternatively, the service environment 104 may be implemented in an on-premises environment (e.g., a home or an office). Service environment 104 may comprise numerous hardware and/or software components and may be subject to one or more distributed computing models/services (e.g., Infrastructure as a Service (IaaS), Platform as a Service (PaaS), Software as a Service (SaaS), Functions as a Service (FaaS)). In aspects, service environment 104 comprises or provides access to computing device 106.

Computing device 106 is configured to manage file storage and file synchronization between client device 102 and computing device 106. In examples, computing device 106 stores a master copy or primary instance of a file and may provide a secondary copy or instance of the file to one or more different devices, such as client device 102. Computing device 106 is configured to detect and/or collect input data and comprises one or more sensor components, as discussed with respect to client device 102. Examples of computing device 106 include server devices (e.g., web servers, file servers, application servers, database servers), edge computing devices (e.g., routers, switches, firewalls, multiplexers), personal computers (PCs), virtual devices, and mobile devices.

Computing device 106 comprises data store 106A, file state monitoring engine 106B, and synchronization mechanism 106C. Data store 106A is configured to store files and content associated with the files, as discussed with respect to data store 102A. In examples, data store 106A comprises hydrated files corresponding to the files stored by data store 102A. For instance, whereas data store 102A stores hydrated and dehydrated files, data store 106A stores the hydrated files corresponding to the hydrated and dehydrated files. In such examples, data store 106A does not (or may not) store dehydrated files. Although data store 106A may not store a hydration state for the files stored thereon (as all of the stored files are hydrated), data store 106A may store hydration states (and additional information) for the corresponding files stored by client device 102.

File state monitoring engine 106B may be configured to monitor files in data store 102A for modifications. In examples, file state monitoring engine 106B implements an event listener mechanism (e.g., a listener function, procedure, or similar functionality). The listener mechanism may be programmed to react to an input or signal indicating the occurrence of a specific event by calling an event handler. In one example, the event corresponds to accessing a file, modifying a file, creating a file, deleting a file, moving a file, copying a file, renaming a file, modifying file privileges, or the expiration of a file. Upon detecting the event, the event handler causes an action to be performed. For instance, the event handler triggers file state monitoring engine 106B to generate a notification indicating that a specified event has occurred for a file stored by data store 106A. The notification is provided to each device comprising a copy or instance of the file. Alternatively, the notification and/or a synchronization instruction is provided to synchronization mechanism 106C. The synchronization instruction may indicate that the file for which the specified event was detected should be refreshed on (e.g., copied to) client device 102.

Synchronization mechanism 106C is configured to refresh files on client device 102 (e.g., synchronize files from data store 106A to data store 102A). In examples, synchronization mechanism 106C receives a refresh notification or instruction for a hydrated file stored by client device 102. In response to the refresh notification or instruction, synchronization mechanism 106C attempts to perform a refresh operation for the hydrated file. The refresh operation is intended to refresh the content of the hydrated file. Upon initiation of the refresh operation and prior to completion of the refresh operation, the refresh operation represents a pending content refresh of the hydrated file. Refreshing the hydrated file may comprise uploading a copy of the file from data store 106A to data store 102A. Alternatively, refreshing the hydrated file may comprise providing client device 102 with a link to location from which client device is able to retrieve the file.

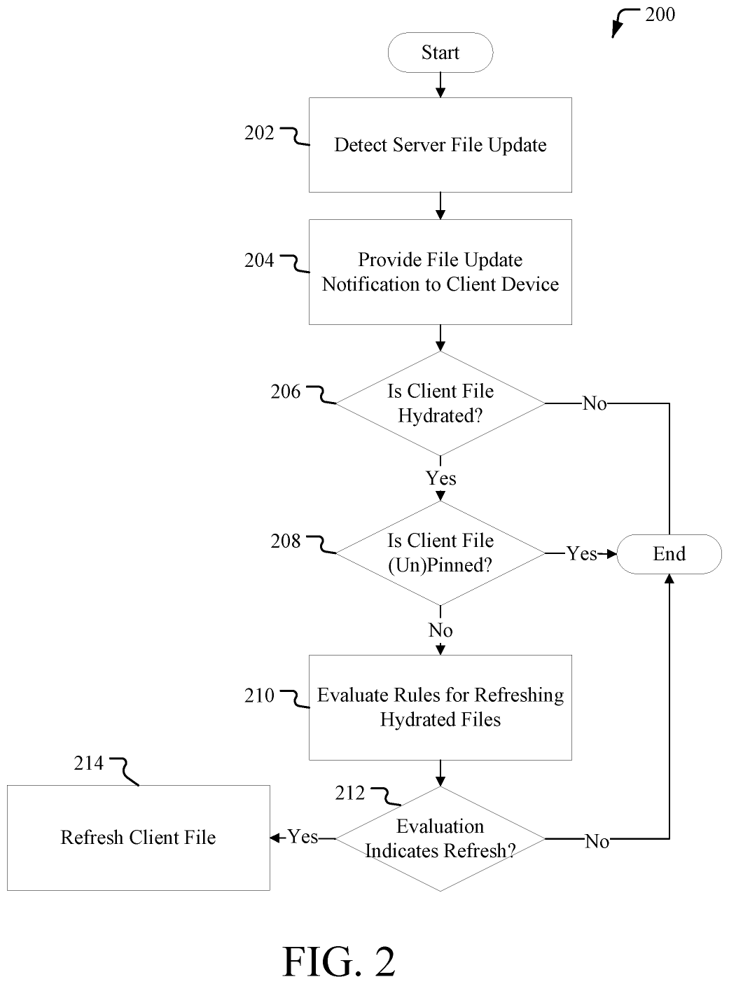

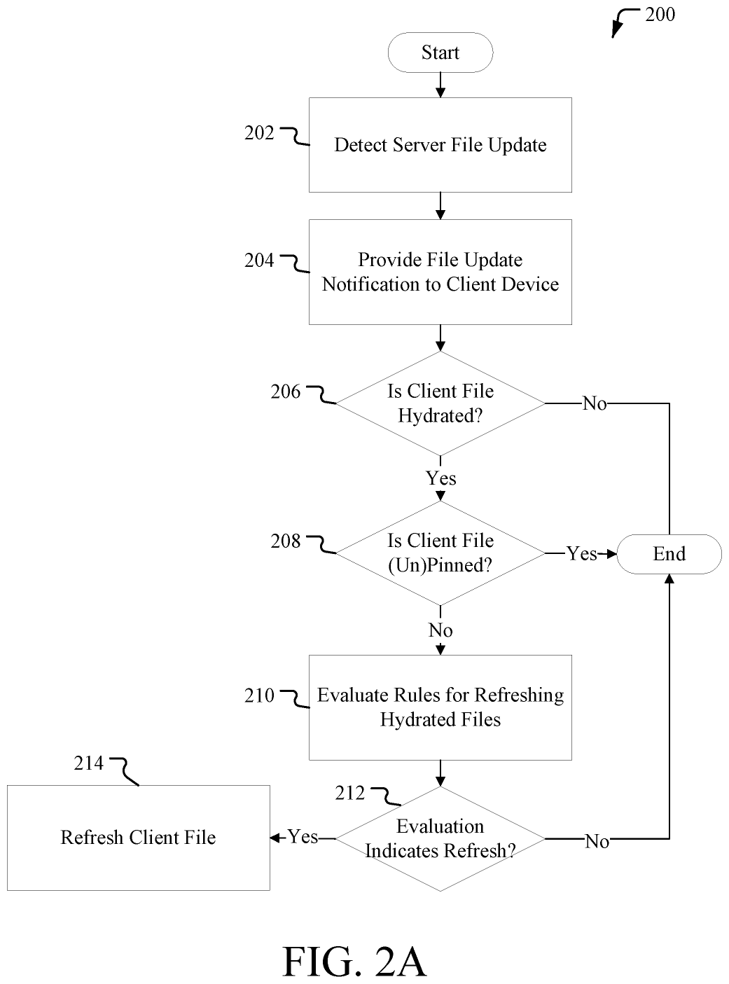

FIG. 2 illustrates an example process flow for maintaining stale files to minimize computing costs. Example process flow 200 is executed in a synchronized computing environment in which files are synchronized between two or more device, such as a client device and a server device. In examples, example process flow 200 is executed by a client device storing at least one hydrated file and zero or more dehydrated files. Although examples in FIG. 2 and subsequent figures will be discussed in the context of a client-server model, the examples may be applicable to other types of models, such as peer-to-peer models and cloud computing models.

Example process flow 200 begins at operation 202, where a file update to a file stored by a server device (“server file”) is detected. In examples, the server file is hydrated and the update corresponds to the modification of the content or metadata of the server file, the modification of the server file itself (e.g., deleting the server file, moving the server file, copying the server file), the expiration or modification of a time-based attribute associated with the server file, or the like.

At operation 204, the server device provides a notification of the file update to a client device that comprises a copy or instance of the server file (“client file”). The notification may be provided in real-time (e.g., as the file update is detected) or at some time interval after the file update is detected at the server device. For example, a script executing periodically on the server device (e.g., every five minutes) may aggregate every notification that occurred during the most recent period of time (e.g., the last five minutes) and provide the notifications to the corresponding client devices.

At decision operation 206, the client device receiving the notification determines whether the client file is hydrated. In examples, a hydrated file comprises an indication of hydration state in the content or metadata of the hydrated file. Determining whether a file is hydrated includes evaluating the hydration state of the file. If the client file is determined to be dehydrated, process flow 200 ends. However, if the client file is determined to be hydrated, process flow 200 proceeds to decision operation 208.

At decision operation 208, the client device determines whether the client file is assigned a Pinned state or an Unpinned state. A Pinned file (e.g., a file assigned a Pinned state) is a file that is to be kept in a hydrated state, where as an Unpinned file (e.g., a file assigned an Unpinned state) is a file that is to be kept in a dehydrated state. If the client file is determined to be Pinned or Unpinned, process flow 200 ends. However, if the client file is determined not to be Pinned or Unpinned, process flow 200 proceeds to decision operation 210.

At operation 210, the client device evaluates a set of rules for refreshing hydrated files. In examples, evaluating the rules comprises using a predictive model or other decision-making logic mechanisms to analyze metadata properties of the hydrated file, current service load characteristics of the client device or the server device, file type classifications for the hydrated file, user usage information, event information, or the like.

At decision operation 212, the client device determines whether the evaluation of the set of rules indicates that the client file should be refreshed. If it is determined that the client file should not be refreshed, the hydrated file is allowed to remain stale and process flow 200 ends. However, if it is determined that the client file should be refreshed, process flow 200 proceeds to operation 214.

At operation 214, the client is refreshed by the client device or the server device. For example, the client device may request a refresh of the client file. Upon receiving the server file, the server is used to refresh the client file. For instance, the client device may replace the client file with the server file or may use the server file to update the client file. Process flow 200 then ends.

Having described one or more systems that may be employed by the aspects disclosed herein, this disclosure will now describe one or more methods that may be performed by various aspects of the disclosure. In aspects, method 300 may be executed by a system, such as system 100 of FIG. 1. However, method 300 is not limited to such examples. In other aspects, method 300 is performed by a single device or component that integrates the functionality of the components of system 100. In at least one aspect, method 300 is performed by one or more components of a distributed network, such as a web service or a cloud service.

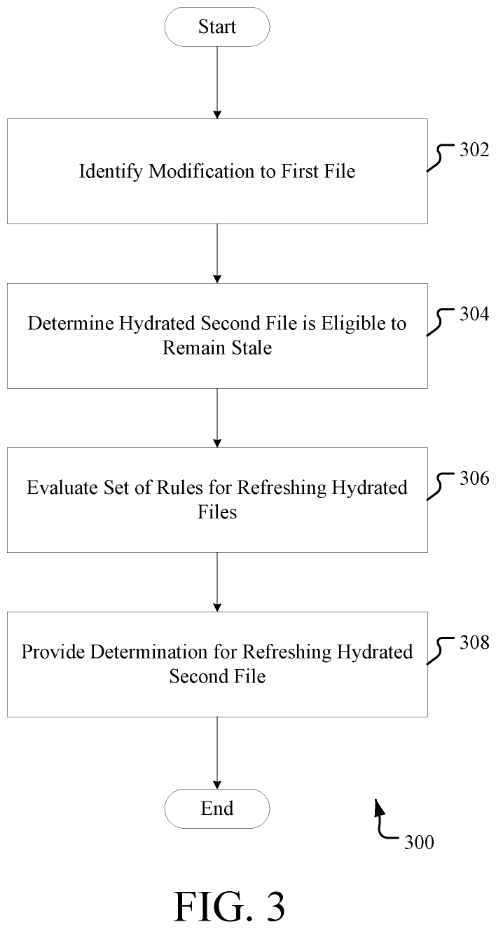

FIG. 3 illustrates an example method for maintaining stale files to minimize computing costs. Example method 300 begins at operation 302, where a modification to a first file stored by a first device, such as computing device 106, is identified by a second device, such as client device 102. The second device may identify the modification to the first file using a monitoring component, such as file state monitoring engine 106B. Alternatively, the second device may receive an indication of the modification to the first file from the first device. In some examples, the modification corresponds to a file event, such as accessing a file, modifying a file, creating a file, deleting a file, moving a file, copying a file, renaming a file, modifying file privileges, or the expiration of a file. The second device comprises or has access to a second file that is hydrated and corresponds to the first file. For instance, the second file may be a copy or instance of the first file. The second file may be stored in a data store, such as data store 102A, that comprises one or more other hydrated and/or dehydrated files.

At operation 304, the second file is determined to be eligible to remain stale. In examples, the determination comprises identifying that the second file is hydrated. The determination further comprises identifying that the hydration state of the second file is not Pinned or Unpinned and the second file is not subject to inheriting the Pinned or Unpinned state. Identifying the hydration state of the hydrated file comprises evaluating file (and/or file folder) properties, metadata, or settings associated with the second file. For instance, the second device may evaluate a metadata tag of the second file to determine the hydration state indicated by the metadata tag. Based on determining that the second file is hydrated and is not Pinned or Unpinned, the second device determines the second file can be allowed to remain temporarily stale (e.g., unrefreshed from the first file).

In some examples, in response to determining the second file is eligible to remain stale, the second device dehydrates the second file and leaves the hydrated second file in neither a Pinned nor Unpinned state. The dehydration of the second file ensures that the second file is not accidently used or read in its stale state. When a user attempts to open, copy, or otherwise interact with the dehydrated second file, the second file may be hydrated and refreshed on demand to bring the file up-to-date.

At operation 306, a set of rules for refreshing hydrated files is evaluated. In examples, the second device may have access to a rules component, such as rules engine 102B. During a period in which the second file is stale (e.g., during a pending content refresh of the second file), the rules component may periodically (or continually) evaluate a set of rules for refreshing hydrated files to determine whether the second file should be refreshed. Evaluating the set of rules comprises using a predictive model or other decision-making logic mechanisms to analyze metadata properties of the second file, current service load characteristics of the first or second device, file type classifications for the second file, user usage information, event information, or the like. As one example, a rule may dictate that a file should be refreshed if members of a user's social circle (e.g., friends, peers, colleagues) have accessed the file (e.g., a copy or instance of the file) a predetermined number of times and/or within a predetermined time frame. For instance, a file is to be refreshed if it accessed at least five times during one week. As another example, a rule may dictate that a file should be refreshed if the file is determined to relate to an upcoming or current event, such as a meeting or a conference. Determining that a file relates to an upcoming event may include applying topic inference or detection techniques to the file and/or the event. For instance, information (e.g., content and metadata) for the file and the event may be scanned to identity respective topics. When topics identified for the file and event match, the file and the event are determined to be related.

At operation 308, a determination for refreshing the second file is provided. In examples, based on the evaluation of the set of rules, the rules component determines whether the second file should be refreshed. Based on the determination, the second device causes or prevents the second file from being refreshed. As one example, the rules component may determine that the second file should not be refreshed at the current time. Accordingly, the second device performs an action to continue to allow the second file to remain temporarily stale. Such action may include ignoring a refresh notification from the first device or preventing execution of a refresh instruction. In another example, the rules component may determine that the second file should be refreshed at the current time. Accordingly, the second device performs an action to facilitate the refresh of the second file. Such action may include providing a refresh request for the second file to the first device or actively retrieving the first file (or a copy or instance of the first file comprising the modification).

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 includes at least one processing unit 402 and a system memory 404. Depending on the configuration and type of computing device, the system memory 404 may comprise volatile storage (e.g., random access memory), non-volatile storage (e.g., read-only memory), flash memory, or any combination of such memories.

The system memory 404 includes an operating system 405 and one or more program modules 406 suitable for running software application 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may include additional data storage devices (removable and/or non-removable) such as, for example, magnetic disks, optical disks, tape, and other computer readable media. Such additional storage is illustrated in FIG. 4 by a removable storage device 407 and a non-removable storage device 410.

The term computer readable media as used herein includes computer storage media. Computer storage media includes volatile and nonvolatile, removable and non-removable media implemented in any method or technology for storage of information, such as computer readable instructions, data structures, or program modules. The system memory 404, the removable storage device 407, and the non-removable storage device 410 are all computer storage media examples (e.g., memory storage). Computer storage media may include random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As stated above, a number of program modules and data files may be stored in the system memory 404. While executing on the processing unit 402, the program modules 406 (e.g., application 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. Output device(s) 414 such as a display, speakers, a printer, etc. may also be included. The aforementioned devices are examples and others may be used. The computing device 400 may include one or more communication connections 416 allowing communications with other computing devices 440. Examples of suitable communication connections 416 include radio frequency (RF) transmitter, receiver, and/or transceiver circuitry; universal serial bus (USB), parallel, and/or serial ports.

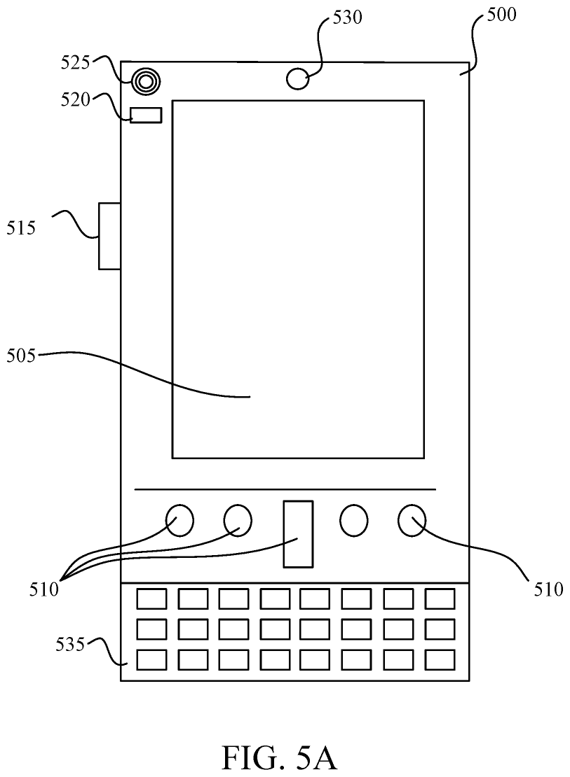

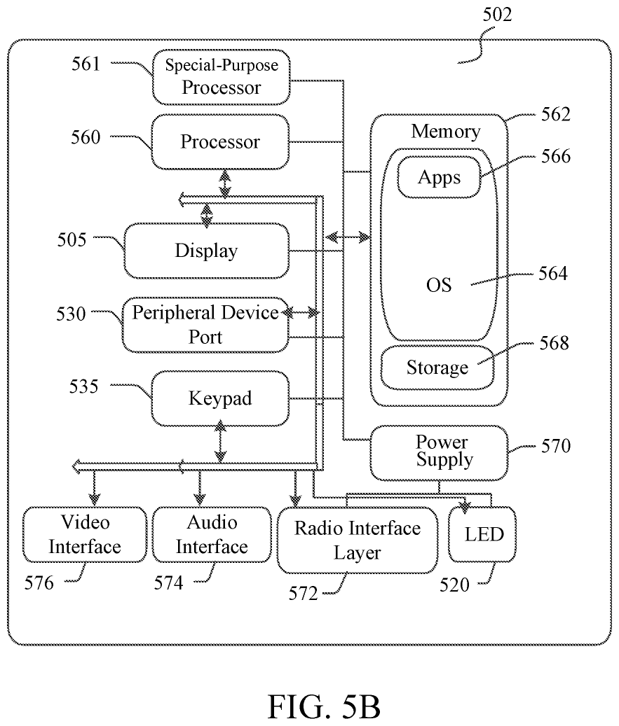

FIGS. 5A and 5B illustrate a mobile computing device 500, for example, a mobile telephone (e.g., a smart phone), wearable computer (such as a smart watch), a tablet computer, a laptop computer, and the like, with which embodiments of the disclosure may be practiced. In some aspects, the client device is a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and may include one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 incorporates more or less input elements. For example, the display 505 may not be a touch screen in some embodiments.

In yet another alternative embodiment, the mobile computing device 500 is a mobile telephone, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system (OS) 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device described herein (e.g., search engine, extractor module, relevancy ranking module, answer scoring module).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the OS 564, and vice versa.

The visual indicator (e.g., light emitting diode (LED) 520) may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone also serves as an audio sensor to facilitate control of notifications, as will be described below. The system 502 may further include a video interface 576 that enables an operation of a peripheral device port 530 (e.g., an on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data may be readily transferred between computing devices for storage and use according to well-known data transfer and storage means, including electronic mail and collaboration data sharing systems.

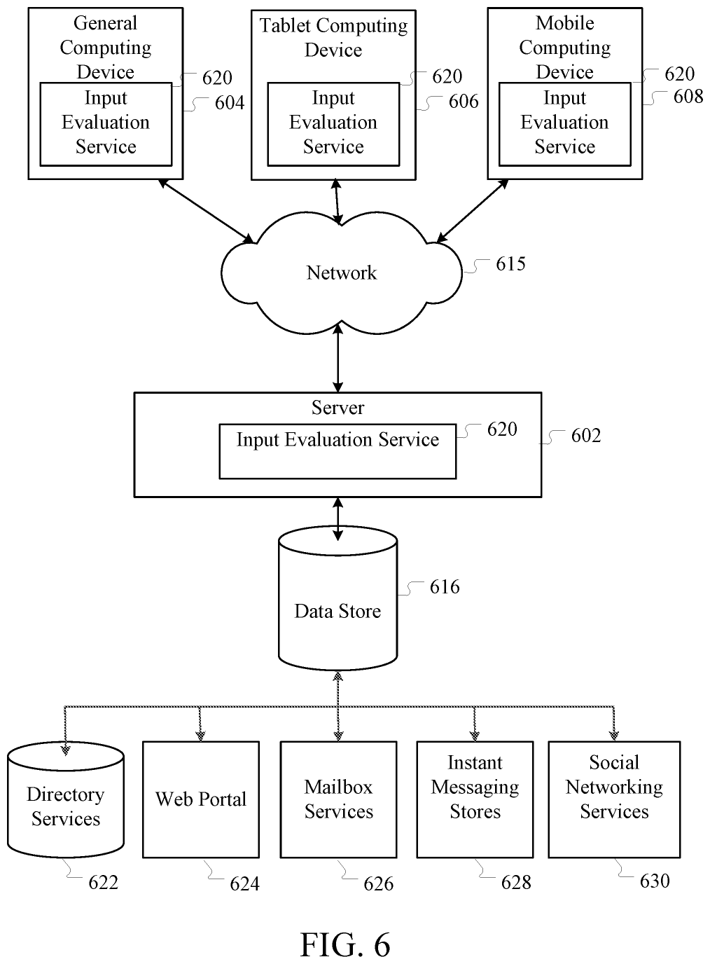

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using directory services 622, web portals 624, mailbox services 626, instant messaging stores 628, or social networking services 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the data store 616, in addition to receiving graphical data useable to be either pre-processed at a graphic-originating system, or post-processed at a receiving computing system.

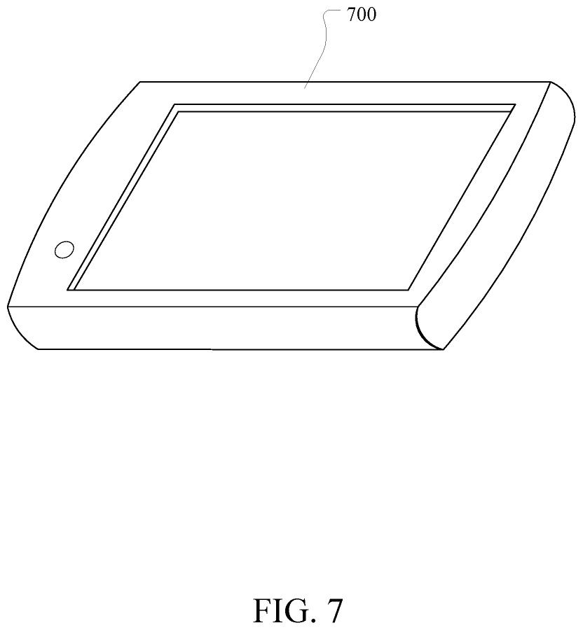

FIG. 7 illustrates an example of a tablet computing device 700 that may execute one or more aspects disclosed herein. In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory coupled to the processor, the memory comprising computer executable instructions that, when executed by the processor, perform a method comprising:
identifying a modification to a first file in a first data store;
determining a second file in a second data store is eligible to remain unrefreshed from the first file, wherein the second file is a hydrated copy of the first file and the second file does not include the modification;
evaluating a set of rules for refreshing hydrated files; and
based on evaluating the set of rules, refreshing the second file.

2. The system of claim 1, wherein the first file is stored by a server device in a file synchronization environment and the second file is stored by a client device in the file synchronization environment.

3. The system of claim 1, wherein the modification to the first file comprises at least one of:
modifying content of the first file;
accessing the first file;
modifying file privileges of the first file; or
expiration of the first file.

4. The system of claim 1, wherein the second data store comprises a dehydrated file, the dehydrated file corresponding to a hydrated file stored in the first data store.

5. The system of claim 4, wherein the dehydrated file is a placeholder file for the corresponding hydrated file stored in the first data store, the placeholder file comprising less than all content of the corresponding hydrated file stored in the first data store.

6. The system of claim 5, wherein the dehydrated file is a zero byte file.

7. The system of claim 1, wherein determining the second file is eligible to remain unrefreshed comprises determining the second file is hydrated and is not Pinned or Unpinned.

8. The system of claim 7, wherein the second file being hydrated indicates an entirety of the first file is stored as the second file on disk of a first device comprising the first data store.

9. The system of claim 7, wherein:
determining the second file is not Pinned comprises determining the second file is not configured to be kept in a hydrated state; and
determining the second file is not Unpinned comprises determining the second file is not configured to be kept in a dehydrated state.

10. The system of claim 1, wherein evaluating the set of rules comprises analyzing at least one of:
metadata properties of the second file; or
service load characteristics of the system.

11. The system of claim 10, wherein the metadata properties comprise at least one of:
last access time; or
last modification date/time.

12. The system of claim 10, wherein the current service load characteristics comprise at least one of:
bandwidth throttling conditions of the system;
conditions during peak and off-peak times; or
computational usage of one or more devices in the system.

13. The system of claim 1, wherein refreshing the second file comprises:
retrieving from the first data store at least one of:
a copy of the first file, the first file comprising the modification; or
the modification to the first file; and
replacing the second file with the first file in the second data store.

14. A method comprising:
identifying a modification to a first file in a first data store of a first device;
determining a second file in a second data store of a second device is eligible to remain unrefreshed from the first file, wherein the second file is a hydrated copy of the first file and the second file does not include the modification;
evaluating a set of rules for refreshing hydrated files; and
based on evaluating the set of rules, causing the second file to not be refreshed.

15. The method of claim 14, wherein:
the first data store comprises one or more hydrated files; and
the second data store comprises one or more dehydrated files.

16. The method of claim 14, wherein determining the second file is eligible to remain unrefreshed comprises determining the second file is hydrated and is not subject to inheriting a Pinned state or an Unpinned state.

17. The method of claim 14, wherein evaluating the set of rules comprises using a predictive model to analyze at least one of:
user usage information for the first file or the second file; and
event information associated with the first file or the second file.

18. The method of claim 17, wherein the user usage information comprises at least one of:
an open event;
a browse event;
an @ mention; or
historical file access times.

19. The method of claim 17, wherein causing the second file to not be refreshed comprises at least one of:
ignoring, by the second device, a refresh notification from the first device; or
preventing, by the second device, execution of a refresh instruction.

20. A method comprising:
determining a file is eligible to remain stale at a time when the file has a pending content refresh, the pending content refresh indicating that the file is not up-to-date;
in response to determining the file is eligible to remain stale, causing the file to remain stale;
during the pending content refresh, detecting a condition indicating that the file is to be refreshed; and
in response to detecting the condition, refreshing the file.
